(19) United States
(12) Patent Application Publication
(10) Pub. No.: US 2016/0069435 A1
(43) Pub. Date: Mar. 10, 2016

(54) SHAFT SUPPORTING STRUCTURE OF BELT-DRIVEN CONTINUOUSLY VARIABLE TRANSMISSION

(71) Applicant: TOYOTA JIDOSHA KABUSHIKI KAISHA, Toyota-shi (JP)

(72) Inventors: Akira IJICHI, Susono-shi (JP); Tatsuya Saito, Susono-shi (JP); Yoshio Ito, Susono-shi (JP)

(73) Assignee: TOYOTA JIDOSHA KABUSHIKI KAISHA, Toyota-shi (JP)

(21) Appl. No.: 14/813,240

(22) Filed: Jul. 30, 2015

(30) Foreign Application Priority Data
Sep. 8, 2014 (JP) 2014-182067

(51) Int. Cl. F16H 9/18; F16H 61/02; F16H 61/662; F16H 57/04

(52) U.S. Cl. CPC F16H 9/18; F16H 57/0489; F16H 57/0471; F16H 61/0265; F16H 61/662

(57) ABSTRACT

A shaft supporting structure of belt-driven continuously variable transmission is provided. The shaft supporting structure comprises a bearing holding the rotary shaft (2) rotatably and a first fixing member (55) fixing the bearing (44) to the casing (20). A fixing point at which the bearing (44) is fixed to the casing (20) by the first fixing member (55) is situated within an area of the casing (20) axially corresponding to one of areas of the sheave (7, 8) defined by a diametrical line passing through an entrance point at which a pin (38) is pulled into a contact zone to the sheaves (7, 8) of a pulley (3), and a diametrical line passing through an exit point from which the pin (38) is withdrawn from the contact zone.

The present invention claims the benefit of Japanese Patent Applications No. 2014-182067 filed on Sep. 8, 2014 with the Japanese Patent Office, the disclosures of which are incorporated herein by reference in its entirety.

### BACKGROUND

1. Field of the Invention

The present invention relates to a belt-driven continuously variable transmission having a pair of pulleys and a belt running on those pulleys, and more particularly, to a structure for supporting a rotary shaft of each pulley.

2. Discussion of the Related Art

JP-A-2006-70916 describes a supporting structure of an oil pump. In the oil pump taught by JP-A-2006-70916, a driven sprocket is connected to a rotary shaft and a drive sprocket is connected to an input shaft of a transmission, and torque of the drive sprocket is transmitted to the driven sprocket through a chain belt. Other end of the oil pump is fixed to a casing. According to the teachings of JP-A-2006-70916, a pump holding member is arranged parallel to a tensile force direction of the chain belt to connect a partition wall member to the pump, for the purpose of suppressing torsional vibrations resulting from torque transmission.

The chain belt is formed by connecting a plurality of plate-like links by pins in a circular manner. In a belt-driven continuously variable transmission, torque is transmitted between a drive pulley and a driven pulley through the chain belt running between sheaves of each pulley. While transmitting the torque between those pulleys, the pins are drawn into a belt groove between the sheaves intermittently and also withdrawn from the belt groove intermittently. When the pin enters into the belt groove, the sheaves of the pulley are pushed by both end of the pin to widen the belt groove temporarily, and the pushing force of the pin to widen the belt groove is mitigated temporality until an entrance of the following pin. Likewise, when the pin is pulled out of the belt groove, the pushing force of the pin to widen the belt groove is mitigated temporality but gradually increased until the following pin is pulled out of the belt groove. As a result of such intermittent change in the pushing force of the pin, vibrations of the rotary shaft would be caused, and the vibrations of the rotary shaft would propagate to the casing.

The present invention has been conceived noting the foregoing technical problems, and it is therefore an object of the present invention is to reduce vibrations of the casing resulting from change in a load of the chain belt pushing the sheaves isolated from each other.

### SUMMARY OF THE INVENTION

The present invention relates to a shaft supporting structure that is applied to a belt-driven continuously variable transmission, comprising: a pair of pulleys respectively comprising a fixed sheave integrated with a rotary shaft, and a movable sheave splined onto the rotary shaft to be rotated integrally therewith while being allowed to reciprocate in an axial direction; a chain belt which is formed by pinning a plurality of circular layers of links together by a plurality of pins, and in which both width ends of each pin serve as power transmission faces; a bearing that holds the rotary shaft rotatably; and a first fixing member that establishes a clamping pressure to fix the bearing to the casing. In order to achieve the above-explained objectives, according to the present invention, a fixing point at which the bearing is fixed to the casing by the first fixing member is situated within an area of the casing axially corresponding to one of areas of the sheave defined by a diametrical line passing through an entrance point at which the pin is pulled into a contact zone to the sheaves of the pulley, and a diametrical line passing through an exit point from which the pin is withdrawn from the contact zone.

Said areas of the sheave include an area where the sheave is vibrated by an entrance of the pin from between the sheaves. The entrance point includes an entrance point of a case in which a minimum speed ratio of the continuously variable transmission is set, and an entrance point in which a maximum speed ratio of the continuously variable transmission is set.

Said areas of the sheave further include an area where the sheave is vibrated by a withdrawal of the pin from between the sheaves. The exit point includes an exit point of a case in which a minimum speed ratio of the continuously variable transmission is set, and an exit point in which a maximum speed ratio of the continuously variable transmission is set.

The shaft supporting structure comprises a second fixing member that establishes a clamping pressure to fix the bearing to the casing within an area of the casing axially corresponding to the other area of said areas of the sheave.

Optionally, the bearing may be clamped between the casing and a stopper plate by the first fixing member.

The belt-driven continuously variable transmission to which the shaft supporting structure is applied further comprises: a hydraulic actuator that applies hydraulic pressure to a back side of the movable sheave to move in the axial direction; and a first oil passage that provides a communication between the actuator and the casing. The first fixing member may fix the bearing to the casing at a point away from the first oil passage.

In addition, the shaft supporting structure of belt-driven continuously variable transmission further comprises a second oil passage that provides a communication between the casing and the bearing. The first fixing member may fix the bearing to the casing at a point away from the second oil passage.

According to the present invention, the bearing holding the rotary shaft is fixed to the casing by the first fixing member at the fixing point situated within the area of the casing axially corresponding to one of the areas of the sheave defined by the diametrical line passing through the entrance point, and the diametrical line passing through the exit point. According to the present invention, therefore, the rotary shaft may be supported rigidly while effectively suppressing vibrations of the casing and the bearing resulting from bowing of the rotary shaft caused by impacts of entrance and withdrawal of the pin into the contact zone to the shaves.

The opposite side of the bearing is fixed to the casing by the second fixing member. For this reason, the bearing can be fixed to the casing further rigidly and hence the vibrations of the casing resulting from the vibrations of the rotary shaft and the bearing can be suppressed more effectively.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a side view of a casing showing one example of a structure to fix a bearing to the casing;

FIG. 2 is a cross-sectional view showing one example of a belt-driven continuously variable transmission;

FIG. 3 is an enlarged view showing one example of a structure of a chain belt;

FIG. 4 is a front view showing one example of a structure of a stopper plate; and

FIG. 5 is view schematically showing positions where the chain belt comes into contact with each sheave and positions where the chain belt is withdrawn from each sheave.

### DETAILED DESCRIPTION OF THE PREFERRED EMBODIMENTS

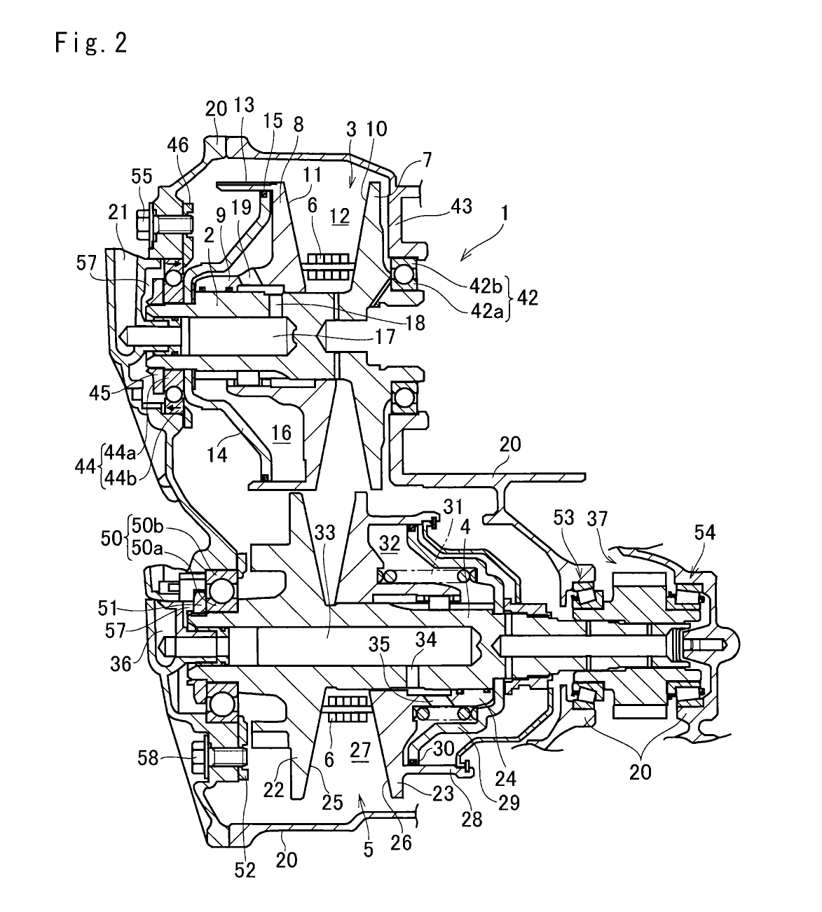

A belt-driven continuously variable transmission to which the present invention is applied comprises a pair of pulleys having a fixed sheave and a movable sheave respectively and a chain belt running on those pulleys. One example of the belt-driven continuously variable transmission will be explained with reference to FIG. 2. The belt-driven continuously variable transmission (to be simply called as the “CVT” hereinafter) 1 shown in FIG. 2 comprises an input shaft 2 to which torque of a prime mover such as an engine is applied, a primary pulley 3 connected to the input shaft 2, an output shaft 4 which transmits torque to an output member such as drive wheels, a secondary pulley 5 connected the output shaft 4, and an endless chain belt 6 applied to the pulleys 3 and 5. The input shaft 2 and the output shaft 4 are arranged parallel to each other.

The primary pulley 3 comprises a first fixed sheave 7 and a first movable sheave 8, and the first fixed sheave 7 is integrated with the input shaft 2. The first movable sheave 8 is splined onto the input shaft 2 to be rotated integrally therewith while being allowed to reciprocate in an axial direction. Specifically, a first hollow boss 9 extends from a rotational center of the first movable sheave 8 toward a back side (i.e., to the left side in FIG. 2), and an inner face of the first boss 9 and an outer face of the input shaft 2 are splined to each other. Each sheave 7, 8 is individually provided with a conical face 10, 11 being opposed each other to form a first V-belt groove 12 therebetween.

A first cylindrical portion 13 extends from an outer circumferential end of the first movable sheave 8 toward the back side, and a first bulkhead 14 is fitted onto the input shaft 2. Specifically, the first bulkhead 14 is shaped into a truncated cone, and an outer circumferential end thereof is brought into contact to an inner face of the first cylindrical portion 13 liquid-tightly through a first sealing member 15. The first bulkhead 14 is fitted onto the input shaft 2 from the leading end side, and axially positioned by a stopper face formed by diametrically increasing the input shaft 2 in such a manner that a leading end of the first boss 9 is prevented from coming into contact with the first bulkhead 14 even when the first movable sheave 8 is withdrawn to the farthest position from the first fixed sheave 7.

A space enclosed liquid-tightly by the first bulkhead 14 and the first cylindrical portion 13 serves as a first hydraulic chamber 16 so that the first movable sheave 8 is pushed toward the first fixed sheave 7 by delivering oil to the first chamber 16. That is, the first chamber 16 is adapted to serve as a hydraulic actuator for applying a hydraulic thrust force to the first movable sheave 8.

A structure for delivering the oil to the first chamber 16 will be briefly explained hereinafter. A first hollow portion 17 is formed from the leading end of the input shaft 2 to a certain extent. In order to provide a communication between the first hollow portion 17 and the first chamber 16, a first through hole 18 penetrates through the input shaft 2 in the vicinity of the innermost portion of the first hollow portion 17 (i.e., right side in FIG. 2), and a second through hole 19 penetrates through the first boss 9. An opening of the first hollow portion 17 is connected with a first passage 21 formed in a casing 20 covering the CVT 1 with auxiliaries such as a not shown torque converter and a torque reversing device. In the primary pulley 3 thus structured, the oil is delivered from the first hollow portion 17 to the first chamber 16 through the first through hole 18 and the second through hole 19. The oil flowing out of the first through hole 18 is also delivered to lubricate the spline engaging the input shaft 2 with the first boss 9.

A structure of the secondary pulley 5 is similar to that of the primary pulley 3. The secondary pulley 5 also comprises a second fixed sheave 22 and a second movable sheave 23, and the second fixed sheave 22 is formed on one end of the output shaft 4 (i.e., left end in FIG. 2). The second movable sheave 23 is splined onto the output shaft 4 to be rotated integrally therewith while being allowed to reciprocate in an axial direction. Specifically, a second hollow boss 24 extends from a rotational center of the second movable sheave 23 toward a back side (i.e., to the right side in FIG. 2), and an inner face of the second boss 24 and an outer face of the output shaft 4 are splined to each other. Each sheave 22, 23 is individually provided with a conical face 25, 26 being opposed each other to form a second V-belt groove 27 therebetween.

A second cylindrical portion 28 extends from an outer circumferential end of the second movable sheave 23 toward the back side, and a second bulkhead 29 is fitted onto the output shaft 4. Specifically, the second bulkhead 29 is also shaped into a truncated cone, and a circumferential end thereof is brought into contact to an inner face of the second cylindrical portion 28 liquid-tightly through a second sealing member 30. A return spring 31 is interposed between the second movable sheave 23 and the second bulkhead 29 to push the second movable sheave 23 toward the second fixed sheave 22. The second bulkhead 29 is fitted onto the output shaft 4 from the leading end side, and axially positioned by a stopper face formed by diametrically increasing the output shaft 4 in such a manner that a leading end of the second boss 24 is prevented from coming into contact with the second bulkhead 29 even when the second movable sheave 23 is withdrawn to the farthest position from the second fixed sheave 22.

A space enclosed liquid-tightly by the second bulkhead 29 and the second cylindrical portion 28 serves as a second hydraulic chamber 32 so that the second movable sheave 23 is pushed toward the second fixed sheave 22 by delivering oil to the second chamber 32. That is, the second chamber 32 is adapted to serve as a hydraulic actuator for applying a hydraulic thrust force to the second movable sheave 23.

A structure for delivering the oil to the second chamber 32 will be briefly explained hereinafter. A second hollow portion 33 is formed from the second fixed sheave 22 side of the output shaft 4 to a certain extent. In order to provide a communication between the second hollow portion 33 and the second chamber 32, a third through hole 34 penetrates through the output shaft 4 in the vicinity of the innermost portion of the second hollow portion 33 (i.e., right side in FIG. 2), and a fourth through hole 35 penetrates through the second boss 24. An opening of the second hollow portion 33 is connected with a second passage 36 formed in the casing 20. In the secondary pulley 5 thus structured, the oil is delivered from the second hollow portion 33 to the second chamber 32 through the third through hole 34 and the fourth through hole 35. The oil flowing out of the third through hole 34 is also delivered to lubricate the spline engaging the output shaft 4 with the second boss 24.

An output gear 37 is splined onto a leading end of the output shaft 4 to deliver torque to not shown drive wheels therethrough.

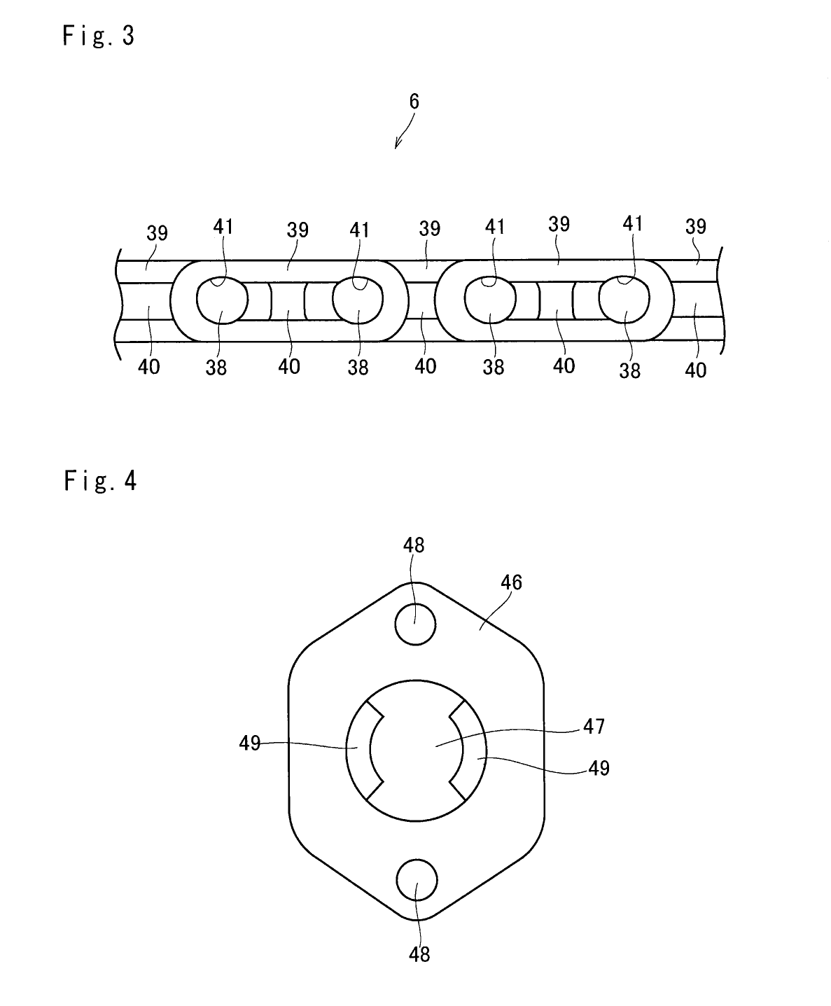

The chain belt 6 is applied to the V-belt grooves 12 and 27 of the primary and the secondary pulleys 3 and 5. Turning to FIG. 3, there is shown an example of a structure of the chain belt 6. The chain belt 6 comprises a plurality of links 39 and a plurality of pins 38. The link 39 is an oval plate member having a space 40, and a pair of pin holders 41 on both corners. An inner diameter of the pin holder 41 is substantially identical to an outer diameter of the pin 38 to hold the pin 38 therein, and an opening width of the space 40 is narrower than the outer diameter of the pin 38 to avoid longitudinal displacement of the pin 38. The links 39 are arranged alternately to one another to form a circular layer, and a plurality of the circular layers of the links 39 are overlapped to one another in such a manner that pin holders 41 of inner and outer links 39 on each corner of the space 40 are individually joined to form a row of pin holes on each corner of the space 40. The pin 38 is individually inserted into each row of pin holes so that the layers of links 39 are pinned together while allowing each link 39 to pivot around the pin 38. In the chain belt 6 thus structured, each width end face 38a of the pin 38 protrudes slightly from the outermost layer of the link 39 to serve as the claimed power transmission face.

The pin 38 may have not only a true circle cross-sectional shape but an oval cross-sectional shape as well. In addition, in order to enhance strength of the chain belt 6, a plurality of pins 38 maybe inserted into the pin hole. In this case, specifically, a pair of pins 38 whose cross-sectional shape is oval are inserted into the pin hole in such a manner that curved contact faces thereof are brought into contact with each other so that a sliding resistance between the contact faces of the pins 38 can be reduced in comparison with that between the pin 38 and the link 39 pivoting therearound.

In addition, a pair of completed pin holes may also be formed in the link 39 instead of the space 40 and the pin holders 41.

Turning back to FIG. 2, a supporting structure of CVT 1 thus structured will be explained. In the example shown in FIG. 2, an end portion of the engine side (i.e., right side in FIG. 2) of the fixed sheave 7 formed integrally with the input shaft 2 is held rotatably by a first bearing 42. To this end, the first fixed sheave 7 is provided with a boss on its back side around a rotational center axis of the input shaft 2, and the casing 20 is provided with an annular wall 43 having a boss on its inner circumferential edge. The first bearing 42 is fitted into a clearance between the boss of the first fixed sheave 7 and the boss of the annular wall 43 while contacting an inner race 42a with the boss of the first fixed sheave 7 and contacting an outer race 42b with the boss of the annular wall 43.

A leading end (i.e., a left end in FIG. 2) of the input shaft 2 is also held rotatably by a second bearing 44. Specifically, an inner race 44a of the second bearing 44 is fitted onto the input shaft 2 in such a manner that one side face thereof is brought into contact with the first bulkhead 14, and the other side face is held by a first fixing member 45 such as a nut while being pushed toward a first bulkhead 14 side. The inner race 44a of the first bearing 44 is thus interposed between the first bulkhead 14 and the first fixing member 45. Meanwhile, an outer race 44b of the second bearing 44 is brought into contact to the casing 20. The casing 20 is provided with an annular protrusion protruding toward the CVT 1 at outer circumferential side of the outer race 44b, and an annular first stopper plate 46 is attached to the annular protrusion of the casing 20 to restrict an axial displacement of the outer race 44b. To this end, specifically, an inner circumferential end of the first stopper plate 46 is brought into contact with a face of the outer race 44b of the bulkhead 14 side. Thus, the outer race 44b of the second bearing 44 is axially positioned by the casing 20 and the inner circumferential end of the first stopper plate 46 attached to the annular protrusion of the casing 20.

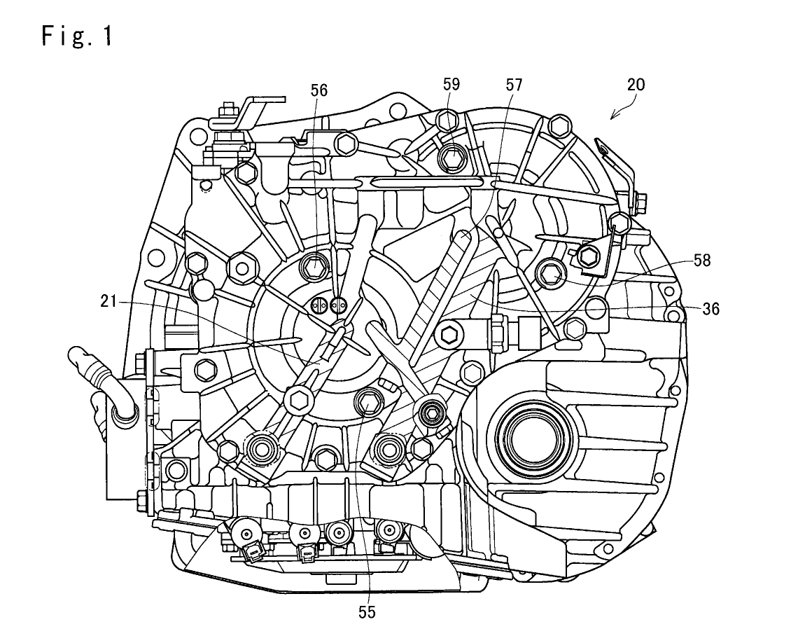

Here will be explained a structure of a first stopper plate 46 in more detail with reference to FIG. 4. As illustrated in FIG. 4, the first stopper plate 46 is shaped into a hexagonal shape, and provided with a fifth through hole 47 at a center. As shown in FIG. 2, the first stopper plate 46 is flush with a portion of the first bulkhead 14. In other words, the first stopper plate 46 is arranged concentrically with an inner circumferential portion (i.e., the left end in FIG. 1) of the first bulkhead 14. That is, an inner diameter of the fifth through hole 47 is larger than outer diameters of the inner circumferential portion of the first bulkhead 14 and the outer race 44b of the second bearing 44. The first stopper plate 46 is fixed to the casing 20 by two bolts, and to this end, tapped holes 48 are formed on the first stopper plate 46 across the fifth through hole 47. In order to restrict an axial displacement of the second bearing 44, the first stopper plate 46 is provided with a stopper 49 to be contacted with the outer race 44b of the second bearing 44. According to the example shown in FIG. 4, a pair of stoppers 49 protrude inwardly from both sides of a line extending through centers of the tapped holes 48 within predetermined areas in the circumferential direction of the fifth through hole 47. Alternatively, the stopper 49 may be formed entirely on the circumference of the fifth through hole 47 to be contacted with the outer race 44b of the second bearing 44. Thus, axial position of the outer race 44b of the second bearing 44 is fixed by attaching the first stopper plate 46 to the casing 20 by screwing the bolt into the tapped hole 48.

Turning back to FIG. 2, one end of the second fixed sheave 22 side of the output shaft 4 is also held rotatably by a third bearing 50. To this end, the second fixed sheave 22 is provided with a boss on its back side around a rotational center axis of the output shaft 4. An inner race 50a of the third bearing 50 is fitted onto the boss of the second fixed sheave 22 in such a manner that one side face thereof is brought into contact with the second fixed sheave 22, and the other side face is held by a second fixing member 51 such as a nut while being pushed toward a second fixed sheave 22 side. Thus, the third bearing 50 is clamped between the second fixed sheave 22 and the second fixing member 51 to restrict an axial displacement thereof. As the outer race 44b of the second bearing 44, an outer race 50b of the third bearing 50 is axially positioned by the casing 20 and an inner circumferential end of a second stopper plate 52 having similar structure as the first stopper plate 46.

As described, the output gear 37 is fitted onto the other end (i.e., the right end in FIG. 1) of the output shaft 4. In order to allow the output gear 37 to rotate together with the output shaft 4, a fourth bearing 53 and a fifth bearing 54 are interposed between each end of the output gear 37 and the casing 20.

Next, an action of the CVT 1 shown in FIG. 2 will be explained. In the CVT 1, engine torque is delivered to the first fixed sheave 7 and the first movable sheave 8 through the input shaft 2, and the torque is further transmitted to the chain belt 6 by a friction force acting between the conical faces 10, 11 and the width end face 38a of the pin 38. The torque of the chain belt 6 is transmitted to the second fixed sheave 22 and the second movable sheave 23, and further transmitted to the output gear 37 through the output shaft 4.

In order to ensure sufficient friction to transmit torque from the primary pulley 3 to the secondary pulley 5 through the chain belt 6, hydraulic pressure applied to the second chamber 32 is increased to increase a thrust load applied to the second movable sheave 23 thereby increasing a clamping force for clamping the chain belt 6 by the second fixed sheave 22 and the second movable sheave 23. As a result, tension of the chain belt 6 running between the primary pulley 3 and the secondary pulley 5 is increased so that the friction force between the chain belt 6 and each first sheave 7 and 8, as well as the friction force between the chain belt 6 and each second sheave 22 and 23 are increased respectively.

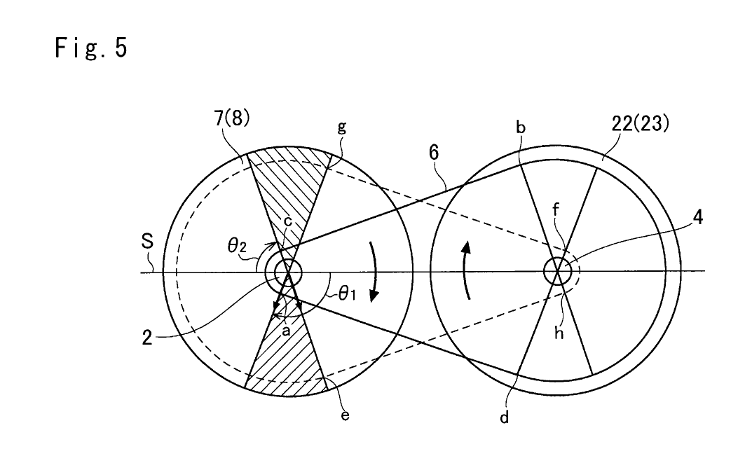

The CVT 1 is adapted to change a speed ratio by changing effective running diameter positions of the chain belt 6 running between the primary pulley 3 and the secondary pulley 5. To this end, a delivery amount of the oil to the first chamber 16 is controlled in accordance with a required speed ratio to move the first movable sheave 8 in the axial direction thereby adjusting a width of the second V-belt groove 27 to achieve the required speed ratio. Here, the chain belt 6 has a sufficient tensile strength not to be elongated during the speed change operation by pushing the second movable sheave 23 toward the second fixed shave 22. Therefore, the width of the second V-belt groove 27 is changed by changing a width of the first V-belt groove 26. Turning to FIG. 5, there is shown positions of the chain belt 6 running between the primary pulley 3 and the secondary pulley 5. In FIG. 5, a solid line represents the chain belt 6 setting the maximum speed ratio of the CVT 1, and a dashed line represents the chain belt 6 setting the minimum speed ratio of the CVT 1.

In the primary pulley 3, a segment from point “a” to point “c” in the rotational direction is a contact zone where the width end faces 38a of the pin 38 come into contact to the conical faces 10 and 11 of the first sheaves 7 and 8 to achieve the maximum speed ratio as indicated by the solid line. That is, the point “a” is an entrance point where the pin 38 is pulled into the contact zone, and the point “c” is an exit point where the pin 38 is withdrawn from the contact zone in case of setting the maximum speed ratio. In this case, in the secondary pulley 5, a segment from point “b” to point “d” in the rotational direction is a contact zone where the width end faces 38a of the pin 38 come into contact to the conical faces 25 and 26 of the second sheaves 22 and 23. That is, the point “b” is an entrance point where the pin 38 is pulled into the contact zone, and the point “d” is an exit point where the pin 38 is withdrawn from the contact zone in case of setting the maximum speed ratio. As described, the effective running diameter positions of the chain belt 6 in the grooves 26 and 27 are changed by the speed change operation of the CVT 1, and hence the above-mentioned points are changed in case of setting the minimum speed ratio as indicated by the dashed line. Specifically, in the primary pulley 3, the entrance point is displaced to point “e” and the exit point is displaced to point “g”. On the other hand, in the secondary pulley 5, the entrance point is displaced to point “f” and the exit point is displaced to point “h”.

As described, each width end face 38a of the pin 38 protrudes slightly from the outermost layer of the link 39 of the chain belt 6 widthwise to transmit power to the sheaves 7, 8 (22, 23). In the CVT 1, therefore, an impact of entrance of the pin 38 into the contact zone of the V-belt groove and an impact of withdrawal of the pin 38 from the contact zone of the V-belt groove cause intermittent vibrations, and such vibrations propagate to the casing 20.

In the chain belt 6, the pins 38 are juxtaposed at constant intervals. As described, the chain belt 6 has a sufficient tensile strength not to be elongated during the speed change operation, and in the primary pulley 3, the chain belt 6 is hydraulically clamped by the sheaves 7 and 8 in a manner not cause a slippage between the width end face 38a of the pin 38 of the chain belt 6 and each conical face 10 and 11 of the first sheaves 7 and 8. When the pin 38 is pulled into the contact zone in the first V-belt groove 12 formed between the conical faces 10 and 11 of the first sheaves 7 and 8, a clearance between the conical faces 10 and 11 of the sheaves 7 and 8, that is, a width of the first V-belt groove 12 is widened by the width end faces 38a of the pin 38 against the clamping pressure of the first sheaves 7 and 8. Consequently, each bearing 42 and 44 individually serves as a support point or a fulcrum, and the input shaft 2 is bowed between the bearings 42 and 44 into a convex configuration by a moment resulting from widening the width of the first V-belt groove 12. In this situation, the input shaft 2 is bowed most significantly at a portion of radially inner side of the contact point between the pin 38 and the conical face 11 of the first movable sheave 8 toward the contact point.

Meanwhile, when the pin 38 is withdrawn from the contact zone in the first V-belt groove 12 formed between the conical faces 10 and 11 of the first sheaves 7 and 8, the clearance between the conical faces 10 and 11 is narrowed by a counteraction of the first movable sheave 8 pushed hydraulically to clamp the chain belt 6. In this case, the input shaft 2 is bowed between the bearings 42 and 44 into a concave configuration by a moment resulting from narrowing of the width of the first V-belt groove 12. Such withdrawal of the pins 38 from the contact zone in the first V-belt groove 12 is caused intermittently. In this situation, the input shaft 2 is bowed most significantly also at the portion of radially inner side of the contact point between the pin 38 and the conical face 11 of the first movable sheave 8 in a direction away from to the exit point. In FIG. 5, arrows on diametrical lines in the primary sheave 3 respectively represent directions that the input shaft 2 is bowed when setting the maximum speed ratio.

As a result of such deformation of the input shaft 2, the second bearing 44 is inclined. For example, in case of setting the maximum speed ratio, the second bearing 44 will be inclined to push the casing 20 outwardly at points axially corresponding to the entrance point “a” and a diametrically symmetrical point of the exit point “c” in the first pulley 3, as indicated by an outward arrow in FIG. 2. In this situation, by contrast, the second bearing 44 will be inclined in a direction to be isolated away from the casing 20 at points axially corresponding to the exit point “c” and a diametrically symmetrical point of the entrance point “a” in the first pulley 3, as indicated by an inward arrow in FIG. 2. As described, since the second bearing 44 is clamped between the casing 20 and the first stopper plate 46 by a first bolt 55, the casing 20 is pulled by an inward motion of the first stopper plate 46.

As described, the pins 38 are inserted into the pin holes of the chain belt 6 and juxtaposed at constant intervals, and hence the load applied to the sheaves 7 and 8 to isolate those members from each other is altered intermittently. Consequently, the input shaft 2 and the second bearing 44 are vibrated by repetition of its deformation and inclination, and vibrations of those elements propagate to the casing 20.

In order to suppress the vibrations of the casing 20 resulting from repetitions of deformation of the input shaft 2 and inclination of the second bearing 44, a position of the first stopper plate 46 fixing the second bearing 44 to the casing 20 is determined in a manner such that the input shaft 2 and the second bearing 44 can be supported firmly.

Here will be explained an effective area to fix the first stopper plate 46 to the casing 20 in such a manner to suppress vibrations of the casing 20. In case of setting the maximum speed ratio of the CVT 1, as shown in FIG. 5, the entrance point of the contact zone between the width end 38a of the pin 38 and the conical face 10 (or) 11 of the first sheave 7 (or 8) in the first V-belt groove 12 is moved to the point “a” rotated at degree θ₁ from a virtual reference plane S passing through the rotational centers of the primary pulley 3 and the secondary pulley 5. On the other hand, the exit point of the above-mentioned contact zone in the first V-belt groove 12 is moved to the point “c” rotated at degree θ₂ from a virtual reference plane S. In this case, when the pin 38 is pulled into the first V-belt groove 12, the input shaft 2 is bowed in a direction of a line passing through the entrance point “a” and the diametrically symmetrical point thereof. By contrast, when the pin 38 is withdrawn from the first V-belt groove 12, the input shaft 2 is bowed in a direction of a line passing through the exit point “c” and the diametrically symmetrical point thereof.

That is, the input shaft 2 is deformed most significantly within hatched areas of FIG. 5 defined by the line passing through the entrance point “a” and the diametrically symmetrical point thereof, and the line passing through the exit point “c” and the diametrically symmetrical point thereof crossing at the rotational center of the primary pulley 3. As described, the second bearing 44 is clamped between the casing 20 and the first stopper plate 46 by the first bolt 55 and a second bolt 56, and hence the first stopper plate 46 and the casing 20 are vibrated together with the second bearing 44 most significantly within areas corresponding to the hatched areas of the first sheave 7 (or 8) of FIG. 5 in the axial direction. In order to suppress vibrations of the casing 20, therefore, it is effective to fix the first stopper plate 46 to the casing 20 by the first bolt 55 and the second bolt 56 within each area of the casing 20 respectively corresponding to the hatched areas of the first sheave 7 (or 8) of FIG. 5 in the axial direction. According to the preferred example, specifically, one end of the first stopper plate 46 is fixed to the casing 20 by the first bolt 55 at a point within the area axially corresponding to one of the hatched areas of FIG. 5, and the other end of the first stopper plate 46 is fixed to the casing 20 by the second bolt 56 at other point within the other area axially corresponding to the other hatched areas of FIG. 5. Accordingly, the first bolt 55 serves as the claimed first fixing member.

FIG. 1 is a side view of a casing 20 showing an example in which one end of the first stopper plate 46 is fixed to the casing 20 by screwing the first bolt 55 into the tapped hole 48 at a point on the line passing through the exit point “c” and the rotational center of the primary pulley 3, and in which the other end of the first stopper plate 46 is fixed to the casing 20 by the second bolt 56 at a diametrically symmetrical point of the exit point “c”.

In the primary pulley 3, the entrance point moves diagonally between the points “a” and “e”, and the exit point moves diagonally between the point “c” and “g” in accordance with the speed ratio of the CVT 1. In order to suppress the vibrations of the casing 20 effectively, the point at which the first stopper plate 46 is fixed to the casing 20 by the first bolt 55 may be adjusted arbitrarily to a point at which the casing 20 is vibrated most significantly within the area of the casing 20 corresponding to the hatched area of the primary pulley 3 including the points “c” and “g” in the axial direction depending on the structure of the CVT 1. Likewise, the point at which the first stopper plate 46 is fixed to the casing 20 by the second bolt 56 may be adjusted arbitrarily to a point at which the casing 20 is vibrated most significantly within the area of the casing 20 corresponding to another hatched area of the primary pulley 3 including the points “a” and “e” in the axial direction depending on the structure of the CVT 1.

Thus, one end of the first stopper plate 46 is fixed to the casing 20 through the second bearing 44 by the first bolt 55 at the point within the area of the casing 20 axially corresponding to the hatched area of the primary pulley 3 shown in FIG. 5. According to the preferred example, therefore, the input shaft 2 can be supported rigidly while suppressing vibrations of the casing 20 by suppressing deformation of the input shaft 2.

The other end of the first stopper plate 46 is fixed to the casing 20 by the second bolt 56 through the second bearing 44 at the point within the area of the casing 20 axially corresponding to the other hatched area of the primary pulley 3 shown in FIG. 5. Accordingly, the second bolt 56 serves as the claimed second fixing member.

Thus, the other end of the first stopper plate 46 is fixed to the casing 20 through the second bearing 44 by the second bolt 56 at the point within the area of the casing 20 axially corresponding to the other hatched area of the primary pulley 3 shown in FIG. 5. According to the preferred example, therefore, the input shaft 2 can be supported rigidly while suppressing vibrations of the casing 20 by suppressing deformation of the input shaft 2 so that the rigidity of the casing 20 can be enhanced entirely. In addition, a number of ribs for enhancing the rigidity of the casing 20 can be reduced.

As described, the casing 20 is provided with the first passage 21 connected to the first chamber 16 and the second passage 36 connected to the second chamber 32, and further provided with a lubrication passage 57 for delivering the oil to the bearing 44 and 50. According to the preferred example, therefore, it is preferable to fix the first stopper plate 46 to the casing 20 by the bolts 55 and 56 at points away from the passages 21, 36 and 57 hatched in FIG. 1.

Additionally, the output shaft 4 is also vibrated by the same principle as the input shaft 2. In order to suppress such vibrations of the output shaft 4, one end of the second stopper plate 52 is fixed to the casing 20 by a third bolt 58 at a point of the casing 20 axially corresponding to one of areas of the secondary pulley 5 defined e.g., by a line passing through the entrance point “b” and a diametrically symmetrical point thereof, and a line passing through the exit point “d” and a diametrically symmetrical point thereof crossing at the rotational center of the secondary pulley 5. Likewise, the other end of the second stopper plate 52 is fixed to the casing 20 by a fourth bolt 59 at a point of the casing 20 axially corresponding to the other area of the secondary pulley 5 defined by the above-mentioned lines.

A number of the fixing point of each stopper plate 46 and 52 to the casing 20 by the bolts is not limited to the forgoing example. In case of fixing the stopper plate to the casing at three or larger points, at least one of the fixing point is situated within the above-explained hatched areas.

Optionally, the second bearing 44 or the third bearing 50 may also be fixed to the casing 20 by fixing the outer race thereof to the casing 20 by a bolt.

What is claimed is:

1. A shaft supporting structure of belt-driven continuously variable transmission, comprising:
a pair of pulleys respectively comprising a fixed sheave integrated with a rotary shaft, and a movable sheave splined onto the rotary shaft to be rotated integrally therewith while being allowed to reciprocate in an axial direction;
a chain belt which is formed by pinning a plurality of circular layers of links together by a plurality of pins, and in which both width ends of each pin serve as power transmission faces;
a bearing that holds the rotary shaft rotatably; and
a first fixing member that establishes a clamping pressure to fix the bearing to the casing;
wherein a fixing point at which the bearing is fixed to the casing by the first fixing member is situated within an area of the casing axially corresponding to one of areas of the sheave defined by a diametrical line passing through an entrance point at which the pin is pulled into a contact zone to the sheaves of the pulley, and a diametrical line passing through an exit point from which the pin is withdrawn from the contact zone.

2. The shaft supporting structure of belt-driven continuously variable transmission as claimed in claim 1,
wherein said areas of the sheave include an area where the sheave is vibrated by an entrance of the pin from between the sheaves, and
wherein the entrance point includes an entrance point of a case in which a minimum speed ratio of the continuously variable transmission is set, and an entrance point in which a maximum speed ratio of the continuously variable transmission is set.

3. The shaft supporting structure of belt-driven continuously variable transmission as claimed in claim 1,
wherein said areas of the sheave include an area where the sheave is vibrated by a withdrawal of the pin from between the sheaves, and
wherein the exit point includes an exit point of a case in which a minimum speed ratio of the continuously variable transmission is set, and an exit point in which a maximum speed ratio of the continuously variable transmission is set.

4. The shaft supporting structure of belt-driven continuously variable transmission as claimed in claim 1, further comprising:
a second fixing member that establishes a clamping pressure to fix the bearing to the casing within an area of the casing axially corresponding to the other area of said areas of the sheave.

5. The shaft supporting structure of belt-driven continuously variable transmission as claimed in claim 1, further comprising:
a stopper plate that clamps the bearing with the casing; and
wherein the bearing is clamped between the casing and the stopper plate by the first fixing member.

6. The shaft supporting structure of belt-driven continuously variable transmission as claimed in claim 1, further comprising:
a hydraulic actuator that applies hydraulic pressure to a back side of the movable sheave to move in the axial direction;
a first oil passage that provides a communication between the actuator and the casing; and
wherein the first fixing member fixes the bearing to the casing at a point away from the first oil passage.

7. The shaft supporting structure of belt-driven continuously variable transmission as claimed in claim 1, further comprising:
a second oil passage that provides a communication between the casing and the bearing; and
wherein the first fixing member fixes the bearing to the casing at a point away from the second oil passage.
